(19) United States
(12) Patent Application Publication
(10) Pub. No.: US 2015/0069072 A1
(43) Pub. Date: Mar. 12, 2015

(54) Portable Cold Storage Pack for a Blood Bag

(71) Applicants: Michelle Kelley, Tewksbury, MA (US); Danielle Kelley, Tewksbury, MA (US)

(72) Inventors: Michelle Kelley, Tewksbury, MA (US); Danielle Kelley, Tewksbury, MA (US)

(21) Appl. No.: 14/073,861

(22) Filed: Nov. 6, 2013

Related U.S. Application Data
(60) Provisional application No. 61/723,275, filed on Nov. 6, 2012.

(51) Int. Cl. A61J 1/16

(52) U.S. Cl. CPC A61J 1/165
USPC 220/592.03

(57) ABSTRACT

A portable, lightweight, storage pack for blood bags which maintains lower temperatures within the blood bags during transport and transfusions. The storage pack has an outer shell with insulated panels and flexible hinges that cover an internal chamber. The storage pack is refrigerated and a blood bag is inserted into the shell through openings. Flexible straps maintain the blood bag in the chilled storage pack during transport and transfusions. These flexible straps permit access to the blood bag access ports to allow transfusions without removing the bag from the chilled shell. A hanging strap on the top of the outer shell hangs the storage pack and the contained blood bag in a vertical position during transfusions.

### CROSS REFERENCE TO RELATED APPLICATION

This application claims the benefit of U.S. Provisional Patent Application No. 61/723,275 filed on Nov. 6, 2012, the contents of which are incorporated herein by reference.

### FIELD OF THE INVENTION

The present invention relates generally to a portable, lightweight, easy to manufacture, storage pack for blood bags that keeps the blood bags at lower temperatures during transport and transfusions.

### BACKGROUND OF THE INVENTION

Blood loss that occurs during accidents, surgeries, or through various diseases must be quickly replaced through intravenous transfusions to give patients a chance of survival, since the human body requires a minimum amount of blood.

Usually, this blood is a homologous donation from an unknown donor, which is stored in blood banks. Storing and transporting human blood, even through various departments in the hospital, is vital to having the resources to saving lives. These human blood products are valuable, liable resources dependent on donations.

Donors are screened for health risks, that could make their blood unsafe for recipients, or could cause donor health risks, i.e. iron needed to carry oxygen is not adequate to donate the required one pint. Once a donor provides the required volume of blood, this blood is screened for viral and bacterial infections, the blood type is determined, and subsequently is stored in blood banks. Blood banks must be in accordance with restrictive requirements under Federal and State laws to ensure safe transfusions. Since human blood is highly sensitive to high temperatures during storage, the blood banks must maintain blood at temperatures of 1 to 6° C.

Collected blood usually has a short viable shelf life. In the United States, certain standards are set for the collection and processing of each blood product. “Whole blood” (WB) is the proper name for one defined product, specifically unseparated venous blood with an approved preservative added. Most blood for transfusion is collected as whole blood. Whole blood is typically separated (via centrifugation) into its components, red blood cells (RBC) in an additive solution and plasma. This blood is contained in individually labeled blood bags. Moreover, the label contains a serial number, the blood type, the date of donation and the location processed.

Units of WB and RBC are both kept refrigerated at 1-6° C., with maximum permitted storage periods (shelf lives) of 35 and 42 days respectively. Due to this short shelf life, blood centers in the U.S. often have difficulty maintaining supplies for even routine transfusion demands.

Often, stored blood that has been removed from the refrigerated blood bank for transfusion is returned unused. However, any blood that is removed from the refrigerated blood banks for infusions must retain an internal temperature of under 10° C. to be returned into the blood bank inventory. If the removed blood has an internal temperature higher than 10° C., the blood must be destroyed according to Federal and State laws.

This destruction of unused blood has massive monetary and supply loss implications for the blood banking system. It may cost as much as $250 to replace each lost blood bag (which does not include the hospital costs associated with preparation of the blood product to be put into inventory and to be transfused). In addition, this further reduces the amount of blood contained in the blood bank, which is already limited due to the number of available, approved blood donors.

Additionally, even blood bags being transfused into a patient is limited for a period of four hours following removal of the blood bag from the blood bank. By keeping the blood at lower temperatures longer, it enables a broader window to transfuse, which can decrease health risks.

In order to maintain the viability of blood for longer periods after removal from a blood bank, a lightweight, easy to use, portable storage pack is needed that maintains the internal temperature of blood below 10° C. for extended periods of time. This device will allow unused blood to be returned to the blood bank to prevent waste of this limited resource. Furthermore, as this device allows blood to stay at decreased temperatures during infusions which allow blood to be infused for periods longer than the current standard of four hours. Lastly, the quality control feature of the temperature device, keeps the blood constantly monitored outside the confines of the regulated blood bank refrigerators. This mechanism insures an established safe temperature is maintained during transfusions.

### SUMMARY OF THE INVENTION

The instant system, as illustrated herein, is clearly not anticipated, rendered obvious, or even present in any of the prior art mechanisms, either alone or in any combination thereof.

Before explaining at least one embodiment of the invention in detail, it is to be understood that the invention is not limited in its application to the details of construction and to the arrangements of the components set forth in the following description or illustrated in the appended drawings. The invention is capable of other embodiments and of being practiced and carried out in various ways. Also, it is to be understood that the phraseology and terminology employed herein are for the purpose of description and should not be regarded as limiting.

The subject invention discloses a portable storage pack for a blood bag that maintains a lower temperature within the blood bag during transport and transfusion, the storage pack comprising: a substantially flat outer shell having a first cover and a second cover being pivotally connected with a first flexible hinge along a first common edge, and a second flexible hinge along a second common edge, wherein the first cover, the second cover, and the flexible hinges each contain insulating material, further wherein the second common edge comprises a hanging strap; an internal cavity within the first cover and the second cover, wherein the internal cavity is configured to removably hold a blood bag, wherein the blood bag comprises two access ports and a label affixed to a first surface of the blood bag; a first opening into the internal cavity that extends along a third common edge of the first cover and the second cover, and a second opening into the internal cavity that extends along a fourth common edge of the first cover and the second cover, wherein the first and second openings are configured to removably receive the blood bag into the internal cavity, wherein a top surface of the first cover further comprises a transparent window into the internal cavity and a temperature gauge that measures the temperature within the internal cavity; wherein prior to insertion of the blood bag into the internal cavity, the storage pack is refrigerated to a temperature of 1 to 6° C., wherein the blood bag is removably inserted into the outer shell through the first opening and the second opening, such that the blood bag access ports are oriented in a direction opposite to the second common edge and the blood bag label is viewable through the transparent window on the top surface of the first cover; a first attachment strap that attaches the first cover to the second cover along the third common edge over the first opening once the blood bag has been inserted; and a second attachment strap attaches the first cover to the second cover along the fourth common edge over the second opening once the blood bag has been inserted, wherein the attached second attachment strap allows both access ports of the blood bag to be accessed through the second opening without removing the blood bag from the outer shell.

The subject invention also discloses a portable storage pack for a blood bag that maintains a lower temperature within the blood bag during transport and transfusion, the storage pack comprising: an outer shell having a front base and a back base being pivotally connected with a first flexible hinge along a left common edge, and a second flexible hinge along a top common edge, wherein the front base, the back base, and the flexible hinges each contain insulating material, further wherein the top common edge comprises a hanging strap; an internal cavity within the front base and the back base, wherein the internal cavity is configured to removably hold a blood bag, wherein the blood bag comprises two access ports and a label affixed to a front surface of the blood bag; a first opening into the internal cavity that extends along a right common edge of the front base and the back base, and a second opening into the internal cavity that extends along a bottom common edge of the front base and the back base, wherein the first and second openings are configured to removably receive the blood bag into the internal cavity, wherein a top surface of the front base further comprises a transparent window into the internal cavity and a temperature gauge that measures the temperature within the internal cavity; wherein prior to insertion of the blood bag into the internal cavity, the storage pack is refrigerated to a temperature of 1 to 6° C., wherein the blood bag is removably inserted into the outer shell through the first opening and the second opening, such that the blood bag access ports are oriented in a bottom direction, opposite to the top common edge and the blood bag label is viewable through the transparent window on the top surface of the front base; a first attachment strap that attaches the front base to the back base along the right common edge over the first opening once the blood bag has been inserted; and a second attachment strap attaches the front base to the back base along the bottom common edge over the second opening once the blood bag has been inserted, wherein the attached second attachment strap allows both access ports of the blood bag to be accessed through the second opening without removing the blood bag from the outer shell.

The subject invention further discloses a portable storage pack for a blood bag that maintains a lower temperature within the blood bag during transport and transfusion, the storage pack comprising: a substantially flat outer shell having a substantially planar first panel and a substantially planar second panel being pivotally connected with a first flexible hinge along a first common edge, and a second flexible hinge along a second common edge, wherein the first panel, the second panel, and the flexible hinges each contain insulating material, further wherein the second common edge comprises a hanging strap; an internal cavity within the first panel and the second panel, wherein the internal cavity is configured to removably hold a blood bag, wherein the blood bag comprises two access ports and a label affixed to a first surface of the blood bag; a first opening into the internal cavity that extends along a third common edge of the first panel and the second panel, and a second opening into the internal cavity that extends along a fourth common edge of the first panel and the second panel, wherein the first and second openings are configured to removably receive the blood bag into the internal cavity, wherein a top surface of the first panel further comprises a transparent window into the internal cavity and a temperature gauge that measures the temperature within the internal cavity; wherein prior to insertion of the blood bag into the internal cavity, the storage pack is refrigerated to a temperature of 1 to 6° C., wherein the blood bag is removably inserted into the outer shell through the first opening and the second opening, such that the blood bag access ports are oriented in a direction opposite to the second common edge and the blood bag label is viewable through the transparent window on the top surface of the first panel; a first attachment strap that attaches the first panel to the second panel along the third common edge over the first opening once the blood bag has been inserted; and a second attachment strap attaches the first panel to the second panel along the fourth common edge over the second opening once the blood bag has been inserted, wherein the attached second attachment strap allows both access ports of the blood bag to be accessed through the second opening without removing the blood bag from the outer shell.

The subject invention discloses a portable storage case for a blood bag that maintains a lower temperature within the blood bag during shipping and transfusion, the storage case comprising: a substantially flat outer housing having a first cover and a second cover being pivotally connected with a first flexible hinge along a first common edge, and a second flexible hinge along a second common edge, wherein the first cover, the second cover, and the flexible hinges each contain insulating material, further wherein the second common edge comprises a hanging strap; an internal chamber within the first cover and the second cover, wherein the internal chamber is configured to removably hold a blood bag, wherein the blood bag comprises two access ports and a label affixed to a first surface of the blood bag; a first opening into the internal chamber that extends along a third common edge of the first cover and the second cover, and a second opening into the internal chamber that extends along a fourth common edge of the first cover and the second cover, wherein the first and second openings are configured to removably receive the blood bag into the internal chamber, wherein a top surface of the first cover further comprises a transparent window into the internal chamber and a temperature gauge that measures the temperature within the internal chamber; wherein prior to insertion of the blood bag into the internal chamber, the storage case is refrigerated to a temperature of 1 to 6° C., wherein the blood bag is removably inserted into the outer housing through the first opening and the second opening, such that the blood bag access ports are oriented in a direction opposite to the second common edge and the blood bag label is viewable through the transparent window on the top surface of the first cover; a first attachment strap that attaches the first cover to the second cover along the third common edge over the first opening once the blood bag has been inserted; and a second attachment strap attaches the first cover to the second cover along the fourth common edge over the second opening once the blood bag has been inserted, wherein the attached second attachment strap allows both access ports of the blood bag to be accessed through the second opening without removing the blood bag from the outer housing.

The subject invention also discloses a portable storage case for a blood bag that maintains a lower temperature within the blood bag during shipping and transfusion, the storage case comprising: an outer housing having a front base and a back base being pivotally connected with a first flexible hinge along a left common edge, and a second flexible hinge along a top common edge, wherein the front base, the back base, and the flexible hinges each contain insulating material, further wherein the top common edge comprises a hanging strap; an internal chamber within the front base and the back base, wherein the internal chamber is configured to removably hold a blood bag, wherein the blood bag comprises two access ports and a label affixed to a front surface of the blood bag; a first opening into the internal chamber that extends along a right common edge of the front base and the back base, and a second opening into the internal chamber that extends along a bottom common edge of the front base and the back base, wherein the first and second openings are configured to removably receive the blood bag into the internal chamber, wherein a top surface of the front base further comprises a transparent window into the internal chamber and a temperature gauge that measures the temperature within the internal chamber; wherein prior to insertion of the blood bag into the internal chamber, the storage case is refrigerated to a temperature of 1 to 6° C., wherein the blood bag is removably inserted into the outer housing through the first opening and the second opening, such that the blood bag access ports are oriented in a bottom direction, opposite to the top common edge and the blood bag label is viewable through the transparent window on the top surface of the front base; a first attachment strap that attaches the front base to the back base along the right common edge over the first opening once the blood bag has been inserted; and a second attachment strap attaches the front base to the back base along the bottom common edge over the second opening once the blood bag has been inserted, wherein the attached second attachment strap allows both access ports of the blood bag to be accessed through the second opening without removing the blood bag from the outer housing.

The subject invention further discloses a portable storage case for a blood bag that maintains a lower temperature within the blood bag during shipping and transfusion, the storage case comprising: a substantially flat outer housing having a substantially planar first panel and a substantially planar second panel being pivotally connected with a first flexible hinge along a first common edge, and a second flexible hinge along a second common edge, wherein the first panel, the second panel, and the flexible hinges each contain insulating material, further wherein the second common edge comprises a hanging strap; an internal chamber within the first panel and the second panel, wherein the internal chamber is configured to removably hold a blood bag, wherein the blood bag comprises two access ports and a label affixed to a first surface of the blood bag; a first opening into the internal chamber that extends along a third common edge of the first panel and the second panel, and a second opening into the internal chamber that extends along a fourth common edge of the first panel and the second panel, wherein the first and second openings are configured to removably receive the blood bag into the internal chamber, wherein a top surface of the first panel further comprises a transparent window into the internal chamber and a temperature gauge that measures the temperature within the internal chamber; wherein prior to insertion of the blood bag into the internal chamber, the storage case is refrigerated to a temperature of 1 to 6° C., wherein the blood bag is removably inserted into the outer housing through the first opening and the second opening, such that the blood bag access ports are oriented in a direction opposite to the second common edge and the blood bag label is viewable through the transparent window on the top surface of the first panel; a first attachment strap that attaches the first panel to the second panel along the third common edge over the first opening once the blood bag has been inserted; and a second attachment strap attaches the first panel to the second panel along the fourth common edge over the second opening once the blood bag has been inserted, wherein the attached second attachment strap allows both access ports of the blood bag to be accessed through the second opening without removing the blood bag from the outer housing.

The subject invention also discloses a method for maintaining blood bags in a cold state during storage, transport, and transfusions, the method comprising: refrigerating a portable storage pack for the blood bag to a temperature of 1 to 6° C., wherein the storage pack comprises a substantially flat outer shell having a first cover and a second cover being pivotally connected with a first flexible hinge along a first common edge, and a second flexible hinge along a second common edge, wherein the first cover, the second cover, and the flexible hinges each contain insulating material, further wherein the second common edge comprises a hanging strap, an internal cavity within the first cover and the second cover, wherein the internal cavity is configured to removably hold the blood bag. a first opening into the internal cavity that extends along a third common edge of the first cover and the second cover, and a second opening into the internal cavity that extends along a fourth common edge of the first cover and the second cover, wherein a top surface of the first cover further comprises a transparent window into the internal cavity and a temperature gauge that measures the temperature within the internal cavity; obtaining the blood bag, wherein the blood bag comprises two access ports and a label affixed to a first surface of the blood bag; inserting the blood bag through the first and second openings of the shell into the internal cavity, such that the blood bag access ports are oriented in a direction opposite to the second common edge and the blood bag label is viewable through the transparent window on the top surface of the first cover; attaching a first attachment strap from the first cover to the second cover along the third common edge over the first opening; and attaching a second attachment strap from the first cover to the second cover along the fourth common edge over the second opening, wherein the attached second attachment strap allows both access ports of the blood bag to be accessed through the second opening without removing the blood bag from the outer shell.

The subject invention discloses a method for transporting blood bags in a refrigerated state, the method comprising: refrigerating a portable storage pack for the blood bag to a temperature of 1 to 6° C., wherein the storage pack comprises a substantially flat outer shell having a first cover and a second cover being pivotally connected with a first flexible hinge along a first common edge, and a second flexible hinge along a second common edge, wherein the first cover, the second cover, and the flexible hinges each contain insulating material, further wherein the second common edge comprises a hanging strap, an internal cavity within the first cover and the second cover, wherein the internal cavity is configured to removably hold the blood bag. a first opening into the internal cavity that extends along a third common edge of the first cover and the second cover, and a second opening into the internal cavity that extends along a fourth common edge of the first cover and the second cover, wherein a top surface of the first cover further comprises a transparent window into the internal cavity and a temperature gauge that measures the temperature within the internal cavity; obtaining the blood bag, wherein the blood bag comprises two access ports and a label affixed to a first surface of the blood bag; inserting the blood bag through the first and second openings of the shell into the internal cavity, such that the blood bag access ports are oriented in a direction opposite to the second common edge and the blood bag label is viewable through the transparent window on the top surface of the first cover; attaching a first attachment strap from the first cover to the second cover along the third common edge over the first opening; attaching a second attachment strap from the first cover to the second cover along the fourth common edge over the second opening; and transporting the blood bag within the storage pack to a designated location.

The subject invention further discloses a method for transfusing blood bags in a cold state, the method comprising: refrigerating a portable storage pack for the blood bag to a temperature of 1 to 6° C., wherein the storage pack comprises a substantially flat outer shell having a first cover and a second cover being pivotally connected with a first flexible hinge along a first common edge, and a second flexible hinge along a second common edge, wherein the first cover, the second cover, and the flexible hinges each contain insulating material, further wherein the second common edge comprises a hanging strap, an internal cavity within the first cover and the second cover, wherein the internal cavity is configured to removably hold the blood bag. a first opening into the internal cavity that extends along a third common edge of the first cover and the second cover, and a second opening into the internal cavity that extends along a fourth common edge of the first cover and the second cover, wherein a top surface of the first cover further comprises a transparent window into the internal cavity and a temperature gauge that measures the temperature within the internal cavity; obtaining the blood bag, wherein the blood bag comprises two access ports and a label affixed to a first surface of the blood bag; inserting the blood bag through the first and second openings of the shell into the internal cavity, such that the blood bag access ports are oriented in a direction opposite to the second common edge and the blood bag label is viewable through the transparent window on the top surface of the first cover; attaching a first attachment strap from the first cover to the second cover along the third common edge over the first opening; and attaching a second attachment strap from the first cover to the second cover along the fourth common edge over the second opening, wherein the attached second attachment strap allows both access ports of the blood bag to be accessed through the second opening without removing the blood bag from the outer shell.

The subject invention also discloses a method for maintaining blood bags in a cold state during storage, shipping, and transfusions, the method comprising: refrigerating a portable storage case for the blood bag to a temperature of 1 to 6° C., wherein the storage case comprises a substantially flat outer housing having a first base and a second base being pivotally connected with a first flexible hinge along a first common edge, and a second flexible hinge along a second common edge, wherein the first base, the second base, and the flexible hinges each contain insulating material, further wherein the second common edge comprises a hanging strap, an internal chamber within the first base and the second base, wherein the internal chamber is configured to removably hold the blood bag. a first opening into the internal chamber that extends along a third common edge of the first base and the second base, and a second opening into the internal chamber that extends along a fourth common edge of the first base and the second base, wherein a top surface of the first base further comprises a transparent window into the internal chamber and a temperature gauge that measures the temperature within the internal chamber; obtaining the blood bag, wherein the blood bag comprises two access ports and a label affixed to a first surface of the blood bag; inserting the blood bag through the first and second openings of the housing into the internal chamber, such that the blood bag access ports are oriented in a direction opposite to the second common edge and the blood bag label is viewable through the transparent window on the top surface of the first base; attaching a first attachment strap from the first base to the second base along the third common edge over the first opening; and attaching a second attachment strap from the first base to the second base along the fourth common edge over the second opening, wherein the attached second attachment strap allows both access ports of the blood bag to be accessed through the second opening without removing the blood bag from the outer housing.

The subject invention also discloses a method for shipping blood bags in a refrigerated state, the method comprising: refrigerating a portable storage case for the blood bag to a temperature of 1 to 6° C., wherein the storage case comprises a substantially flat outer housing having a first base and a second base being pivotally connected with a first flexible hinge along a first common edge, and a second flexible hinge along a second common edge, wherein the first base, the second base, and the flexible hinges each contain insulating material, further wherein the second common edge comprises a hanging strap, an internal chamber within the first base and the second base, wherein the internal chamber is configured to removably hold the blood bag. a first opening into the internal chamber that extends along a third common edge of the first base and the second base, and a second opening into the internal chamber that extends along a fourth common edge of the first base and the second base, wherein a top surface of the first base further comprises a transparent window into the internal chamber and a temperature gauge that measures the temperature within the internal chamber; obtaining the blood bag, wherein the blood bag comprises two access ports and a label affixed to a first surface of the blood bag; inserting the blood bag through the first and second openings of the housing into the internal chamber, such that the blood bag access ports are oriented in a direction opposite to the second common edge and the blood bag label is viewable through the transparent window on the top surface of the first base; attaching a first attachment strap from the first base to the second base along the third common edge over the first opening; attaching a second attachment strap from the first base to the second base along the fourth common edge over the second opening; and shipping the blood bag within the storage case to a designated location.

The subject invention further discloses a method for transfusing blood bags in a cold state, the method comprising: refrigerating a portable storage case for the blood bag to a temperature of 1 to 6° C., wherein the storage case comprises a substantially flat outer housing having a first base and a second base being pivotally connected with a first flexible hinge along a first common edge, and a second flexible hinge along a second common edge, wherein the first base, the second base, and the flexible hinges each contain insulating material, further wherein the second common edge comprises a hanging strap, an internal chamber within the first base and the second base, wherein the internal chamber is configured to removably hold the blood bag. a first opening into the internal chamber that extends along a third common edge of the first base and the second base, and a second opening into the internal chamber that extends along a fourth common edge of the first base and the second base, wherein a top surface of the first base further comprises a transparent window into the internal chamber and a temperature gauge that measures the temperature within the internal chamber; obtaining the blood bag, wherein the blood bag comprises two access ports and a label affixed to a first surface of the blood bag; inserting the blood bag through the first and second openings of the housing into the internal chamber, such that the blood bag access ports are oriented in a direction opposite to the second common edge and the blood bag label is viewable through the transparent window on the top surface of the first base; attaching a first attachment strap from the first base to the second base along the third common edge over the first opening; and attaching a second attachment strap from the first base to the second base along the fourth common edge over the second opening, wherein the attached second attachment strap allows both access ports of the blood bag to be accessed through the second opening without removing the blood bag from the outer housing.

The subject invention also discloses a method for maintaining blood bags in a cold state during storage, shipping, and transfusions, the method comprising: refrigerating a portable storage case for the blood bag to a temperature of 1 to 6° C., wherein the storage case comprises a substantially flat outer housing having a front cover and a back cover being pivotally connected with a first flexible hinge along a left common edge, and a second flexible hinge along a top common edge, wherein the front cover, the back cover, and the flexible hinges each contain insulating material, further wherein the top common edge comprises a hanging strap, an internal chamber within the front cover and the back cover, wherein the internal chamber is configured to removably hold the blood bag. a first opening into the internal chamber that extends along a right common edge of the front cover and the back cover, and a second opening into the internal chamber that extends along a bottom common edge of the front cover and the back cover, wherein a top surface of the front cover further comprises a transparent window into the internal chamber and a temperature gauge that measures the temperature within the internal chamber; obtaining the blood bag, wherein the blood bag comprises two access ports and a label affixed to a first surface of the blood bag; inserting the blood bag through the first and second openings of the housing into the internal chamber, such that the blood bag access ports are oriented in a direction opposite to the top common edge and the blood bag label is viewable through the transparent window on the top surface of the front cover; attaching a first attachment strap from the front cover to the back cover along the right common edge over the first opening; and attaching a second attachment strap from the front cover to the back cover along the bottom common edge over the second opening, wherein the attached second attachment strap allows both access ports of the blood bag to be accessed through the second opening without removing the blood bag from the outer housing.

The subject invention also discloses a method for shipping blood bags in a refrigerated state, the method comprising: refrigerating a portable storage case for the blood bag to a temperature of 1 to 6° C., wherein the storage case comprises a substantially flat outer housing having a front cover and a back cover being pivotally connected with a first flexible hinge along a left common edge, and a second flexible hinge along a top common edge, wherein the front cover, the back cover, and the flexible hinges each contain insulating material, further wherein the top common edge comprises a hanging strap, an internal chamber within the front cover and the back cover, wherein the internal chamber is configured to removably hold the blood bag. a first opening into the internal chamber that extends along a right common edge of the front cover and the back cover, and a second opening into the internal chamber that extends along a bottom common edge of the front cover and the back cover, wherein a top surface of the front cover further comprises a transparent window into the internal chamber and a temperature gauge that measures the temperature within the internal chamber; obtaining the blood bag, wherein the blood bag comprises two access ports and a label affixed to a first surface of the blood bag; inserting the blood bag through the first and second openings of the housing into the internal chamber, such that the blood bag access ports are oriented in a direction opposite to the top common edge and the blood bag label is viewable through the transparent window on the top surface of the front cover; attaching a first attachment strap from the front cover to the back cover along the right common edge over the first opening; attaching a second attachment strap from the front cover to the back cover along the bottom common edge over the second opening; and shipping the blood bag within the storage case to a designated location.

The subject invention further discloses a method for transfusing blood bags in a cold state, the method comprising: refrigerating a portable storage case for the blood bag to a temperature of 1 to 6° C., wherein the storage case comprises a substantially flat outer housing having a front cover and a back cover being pivotally connected with a first flexible hinge along a left common edge, and a second flexible hinge along a top common edge, wherein the front cover, the back cover, and the flexible hinges each contain insulating material, further wherein the top common edge comprises a hanging strap, an internal chamber within the front cover and the back cover, wherein the internal chamber is configured to removably hold the blood bag. a first opening into the internal chamber that extends along a right common edge of the front cover and the back cover, and a second opening into the internal chamber that extends along a bottom common edge of the front cover and the back cover, wherein a top surface of the front cover further comprises a transparent window into the internal chamber and a temperature gauge that measures the temperature within the internal chamber; obtaining the blood bag, wherein the blood bag comprises two access ports and a label affixed to a first surface of the blood bag; inserting the blood bag through the first and second openings of the housing into the internal chamber, such that the blood bag access ports are oriented in a direction opposite to the top common edge and the blood bag label is viewable through the transparent window on the top surface of the front cover; attaching a first attachment strap from the front cover to the back cover along the right common edge over the first opening; and attaching a second attachment strap from the front cover to the back cover along the bottom common edge over the second opening, wherein the attached second attachment strap allows both access ports of the blood bag to be accessed through the second opening without removing the blood bag from the outer housing.

In further embodiments of the subject invention, the front or first cover, panel, or base may further comprises a first pocket on an internal surface, wherein the first pocket is configured to removably, or non-removably, hold a plurality of refrigerated gel packs in a readily accessible position.

In other embodiments of the subject invention, the back or second cover, panel, or base may further comprises a second pocket on an internal surface, wherein the second pocket is configured to removably, or non-removably, hold a plurality of refrigerated gel packs in a readily accessible position.

In additional embodiments of the subject invention, the first flexible hinge may further comprise a third pocket on an internal surface, wherein the third pocket is configured to removably, or non-removably, hold a plurality of refrigerated gel packs in a readily accessible position.

In further embodiments of the subject invention, the second flexible hinge may further comprise a fourth pocket on an internal surface, wherein the fourth pocket is configured to removably, or non-removably, hold a plurality of refrigerated gel packs in a readily accessible position.

In embodiments of the subject invention, the blood bag may comprise a size that holds a liquid volume of 50 ml to 2000 ml.

In further embodiments of the subject invention, the internal surface of the shell or housing may comprise a mesh for holding the blood bag within the cavity or chamber.

In additional embodiments of the subject invention, the hanging strap may allow the pack to be attached to an intravenous (IV) pole and allows for easy suspension of the storage pack and the contained blood bag in a vertical position during transfusions.

In other embodiments of the subject invention, the first and second attachment straps may comprise hook and loop fastener straps.

In further embodiments of the subject invention, the blood bag may further comprises a patient tag, wherein the first attachment strap allows access to the patient tag without removing the blood bag from the outer shell.

In even further embodiments of the subject invention, the front and back or first and second covers, bases, or panels may each be 3 to 12 inches in height.

In additional embodiments of the subject invention, the front and back or first and second covers, bases, or panels may each be 2 to 10 inches in width.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a front view of one embodiment of the portable cold blood bag storage pack without a blood bag.

FIG. 2 illustrates another front view of a standard blood bag.

FIG. 3 illustrates a further front view of one embodiment of the portable cold blood bag storage pack containing a blood bag.

### DETAILED DESCRIPTION OF THE PREFERRED EMBODIMENTS

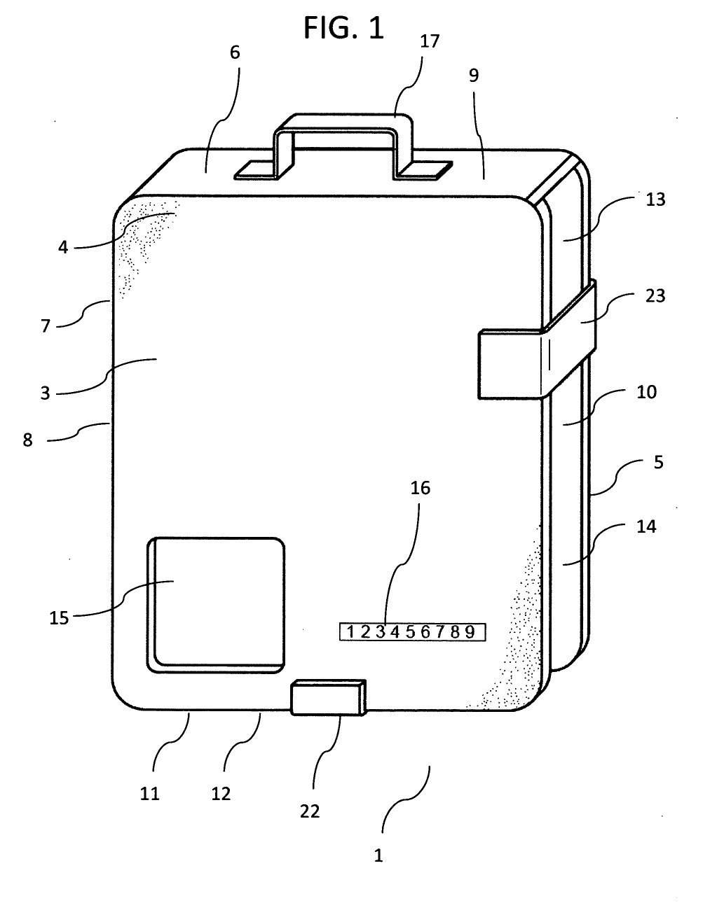

As illustrated in FIG. 1, the subject invention is a portable, lightweight, easy to manufacture, storage pack 1 for blood bags 2 that keeps the bags 2 at lower temperatures during transport and transfusions.

The storage pack 1 is comprised of lightweight, flexible, soft, substantially rectangular-shaped, outer shell 3. This shell 3 is comprised of substantially flat and rectangular-shaped front 4 and back 5 bases containing insulating material. Two soft, flexible hinges 6 and 7, also containing insulating material, connects both bases 4, 5 along a left common edge 8 and a top common edge 9. This shell 3 may be heat-sealed, stitched, or glued together with adhesives known to those skilled in the art. The front and back bases 4, 5, and hinges 6, 7 may all contain a removable or non-removable refrigerated gel packs (not shown). The top common edge 9 further contains a hanging strap 17.

The shell 3 further contains an internal cavity 10 configured to removably hold a standard blood bag 2. The internal surface of the shell 3 is lined with mesh to hold the blood bag without interfering with blood transfusion. The shell 3 comprises a horizontal opening 11 that extends along the bottom edge 12 and a vertical opening 13 that extends along the right edge 14 for inserting and removing a blood bag 2 from the shell 3.

The top surface of front base 4 further comprises a transparent window 15 that views directly into internal cavity 10. This transparent window 15 does not contain any internal gel packs.

The top surface of front base 4 also comprises a temperature gauge 16 that measures the temperature within internal cavity 10. This temperature gauge 16 does not contain any internal gel packs.

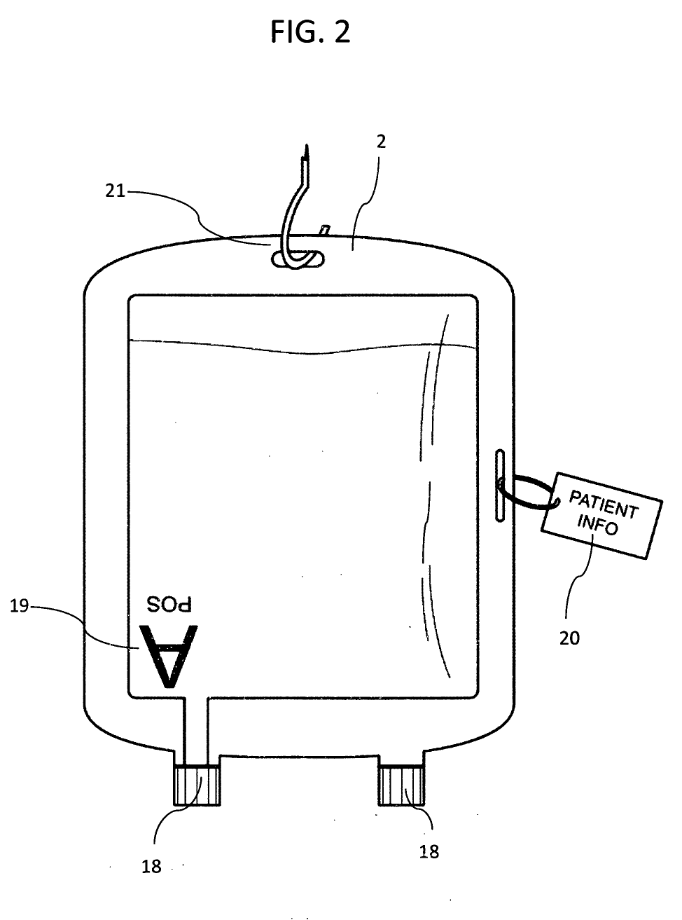

FIG. 2 illustrates a standard blood bag 2. This blood bag 2 is composed of a flexible, soft synthetic resin or plastic and is capable of holding blood. The blood bag has two access ports 18. These access ports 18 are usually covered to avoid contamination. A label 19 is affixed on the surface of the blood bag 2. The blood bag 2 also contains a patient information tag 20 on the left side. A strap 21 on the top of the bag 2 allows the bag 2 to attach to an intravenous (IV) pole and allows for easy suspension of the bag 2 in a vertical position during transfusions.

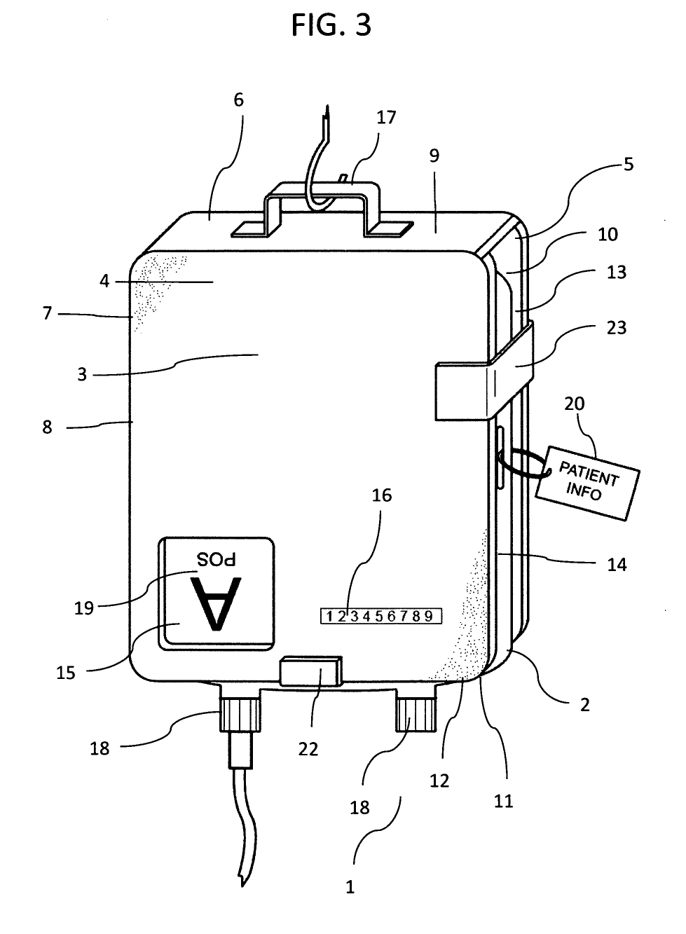

FIG. 3 illustrates the portable cold blood bag storage pack 1 containing a blood bag 2. Prior to insertion of a blood bag, the pack 1 is refrigerated to a low temperate of 1-6° C. This refrigeration cools the gel packs contained in the front and back bases 4, 5, and hinges 6, 7 of the shell 3. A blood bag 2 is removably inserted into the shell 3 of the pack 1 through horizontal opening 11 that extends along the bottom edge 12 and a vertical opening 13 that extends along the right edge 14. The internal surface of the shell 3 is lined with mesh to hold the blood bag without interfering with blood transfusion.

The blood bag 2 is inserted into the internal cavity 10 of the shell 3 such that the label 19 is viewable through the transparent window 15 on the top surface of front base 4. This configuration allows nurses and other medical providers to confirm the blood type of the blood bag 2 contained within the pack 1 without the need for removing the bag 2 from the shell 3.

Once the blood bag 2 is fully inserted into the internal cavity 10 of the shell 3, a first, flexible attachment device 22, such as a Velcro® strap, attaches the bottom of front base 4 to the bottom of back base 5 over horizontal opening 11 along the bottom edge 12. This attachment device 22 maintains the blood bag 2 within the shell 3. This attachment device strap 22 allows both ports 18 on the blood bag 2 to be accessed for transfusion without removing the blood bag 2 from the shell 3.

Once the blood bag 2 is fully inserted into the internal cavity 10 of the shell 3, a second, flexible attachment device 23, such as a Velcro® strap, attaches the right side of front base 4 to the right side of back base 5 over vertical opening 13 along the right edge 14. This attachment device 23 maintains the blood bag 2 within the shell 3. This attachment device strap 23 allows the patient information tag 20 on the blood bag 2 to be accessed for patient identification without removing the blood bag 2 from the shell 3.

The top-hanging strap 17 on the top common edge 9 of the pack 1 allows the pack 1 and the blood bag 2 contained within to be placed on IV pole for long transfusions.

These blood bags can be transfused into a patient for periods longer than four hours following removal of the blood bag from the blood bank

The cooled refrigerated gel packs contained in the front and back bases 4, 5, and hinges 6,7 of the shell 3 keep the internal temperature of internal cavity 10 and the blood bag 2 contained within below 10° C. for extended periods of time. The temperature gauge 16 on the top surface of front base 4 of the pack 1 allows medical service providers to quickly determine the internal temperature of the contained blood bag 2 without removing it from the shell 3. As long as the internal temperature of the blood bag 2 remains under 10° C., any unused blood bag 2 contained within packs 1 may be returned to the blood bank. Furthermore, these blood bags can be transfused into a patient for periods longer than four hours following removal of the blood bag from the blood bank.

What is claimed is:

1. A portable storage pack for a blood bag that maintains a lower temperature within the blood bag during transport and transfusion, the storage pack comprising:
a substantially flat outer shell having a first cover and a second cover being pivotally connected with a first flexible hinge along a first common edge, and a second flexible hinge along a second common edge, wherein the first cover, the second cover, and the flexible hinges each contain insulating material, further wherein the second common edge comprises a hanging strap;
an internal cavity within the first cover and the second cover, wherein the internal cavity is configured to removably hold a blood bag, wherein the blood bag comprises two access ports and a label affixed to a first surface of the blood bag;
a first opening into the internal cavity that extends along a third common edge of the first cover and the second cover, and a second opening into the internal cavity that extends along a fourth common edge of the first cover and the second cover, wherein the first and second openings are configured to removably receive the blood bag into the internal cavity,
wherein a top surface of the first cover further comprises a transparent window into the internal cavity and a temperature gauge that measures the temperature within the internal cavity;
wherein prior to insertion of the blood bag into the internal cavity, the storage pack is refrigerated to a temperature of 1 to 6° C.,
wherein the blood bag is removably inserted into the outer shell through the first opening and the second opening, such that the blood bag access ports are oriented in a direction opposite to the second common edge and the blood bag label is viewable through the transparent window on the top surface of the first cover;
a first attachment strap that attaches the first cover to the second cover along the third common edge over the first opening once the blood bag has been inserted; and
a second attachment strap attaches the first cover to the second cover along the fourth common edge over the second opening once the blood bag has been inserted, wherein the attached second attachment strap allows both access ports of the blood bag to be accessed through the second opening without removing the blood bag from the outer shell.

2. The portable storage pack of claim 1, wherein the first cover further comprises a first pocket on an internal surface, wherein the first pocket is configured to removably hold a plurality of refrigerated gel packs in a readily accessible position.

3. The portable storage pack of claim 1, wherein the second cover further comprises a second pocket on an internal surface, wherein the second pocket is configured to removably hold a plurality of refrigerated gel packs in a readily accessible position.

4. The portable storage pack of claim 1, wherein the first flexible hinge further comprise a third pocket on an internal surface, wherein the third pocket is configured to hold a plurality of refrigerated gel packs in a readily accessible position.

5. The portable storage pack of claim 1, wherein the second flexible hinge further comprise a fourth pocket on an internal surface, wherein the fourth pocket is configured to removably hold a plurality of refrigerated gel packs in a readily accessible position.

6. The portable storage pack of claim 1, wherein the blood bag comprises a size that holds a liquid volume of 50 ml to 1,000 ml.

7. The portable storage pack of claim 1, wherein the internal surface of the shell comprises a mesh for holding the blood bag within the cavity.

8. The portable storage pack of claim 1, wherein the hanging strap allows the pack to be attached to an intravenous (IV) pole and allows for suspension of the storage pack and the contained blood bag in a vertical position during transfusions.

9. The portable storage pack of claim 1, wherein the first and second attachment straps comprise hook and loop fastener straps.

10. The portable storage pack of claim 1, wherein the blood bag further comprises a patient tag, wherein the first attachment strap allows access to the patient tag without removing the blood bag from the outer shell.

11. A method for maintaining blood bags in a cold state during storage, transport, and transfusions, the method comprising
refrigerating a portable storage pack for the blood bag to a temperature of 1 to 6° C., wherein the storage pack comprises a substantially flat outer shell having a first cover and a second cover being pivotally connected with a first flexible hinge along a first common edge, and a second flexible hinge along a second common edge, wherein the first cover, the second cover, and the flexible hinges each contain insulating material, further wherein the second common edge comprises a hanging strap, an internal cavity within the first cover and the second cover, wherein the internal cavity is configured to removably hold the blood bag. a first opening into the internal cavity that extends along a third common edge of the first cover and the second cover, and a second opening into the internal cavity that extends along a fourth common edge of the first cover and the second cover, wherein a top surface of the first cover further comprises a transparent window into the internal cavity and a temperature gauge that measures the temperature within the internal cavity;
obtaining the blood bag, wherein the blood bag comprises two access ports and a label affixed to a first surface of the blood bag;
inserting the blood bag through the first and second openings of the shell into the internal cavity, such that the blood bag access ports are oriented in a direction opposite to the second common edge and the blood bag label is viewable through the transparent window on the top surface of the first cover;
attaching a first attachment strap from the first cover to the second cover along the third common edge over the first opening; and
attaching a second attachment strap from the first cover to the second cover along the fourth common edge over the second opening, wherein the attached second attachment strap allows both access ports of the blood bag to be accessed through the second opening without removing the blood bag from the outer shell.

12. The method of claim 11, wherein the first cover further comprises a first pocket on an internal surface, wherein the first pocket is configured to removably hold a plurality of refrigerated gel packs in a readily accessible position.

13. The method of claim 11, wherein the second cover further comprises a second pocket on an internal surface, wherein the second pocket is configured to removably hold a plurality of refrigerated gel packs in a readily accessible position.

14. The method of claim 11, wherein the first flexible hinge further comprise a third pocket on an internal surface, wherein the third pocket is configured to hold a plurality of refrigerated gel packs in a readily accessible position.

15. The method of claim 11, wherein the second flexible hinge further comprise a fourth pocket on an internal surface, wherein the fourth pocket is configured to removably hold a plurality of refrigerated gel packs in a readily accessible position.

16. The method of claim 11, wherein the blood bag comprises a size that holds a liquid volume of 50 ml to 1,000 ml.

17. The method of claim 11, wherein the internal surface of the shell comprises a mesh for holding the blood bag within the cavity.

18. The method of claim 11, wherein the hanging strap allows the pack to be attached to an intravenous (IV) pole and allows for suspension of the storage pack and the contained blood bag in a vertical position during transfusions.

19. The method of claim 11, wherein the first and second attachment straps comprise hook and loop fastener straps.

20. The method of claim 11, wherein the blood bag further comprises a patient tag, wherein the first attachment strap allows access to the patient tag without removing the blood bag from the outer shell.
